(19) United States
(12) Patent Application Publication
(10) Pub. No.: US 2007/0012894 A1
(43) Pub. Date: Jan. 18, 2007

(54) Vacuum gate valve

(75) Inventor: Hwa-Fu Chen, Hsinchu (TW)

Correspondence Address: Hwa-Fu Chen;Apt. 3D, 3620 168th St., Flushing, NY, 11358, US

(73) Assignee: G-LIGHT DISPLAY CORP.

(21) Appl. No.: 11/183,206

(22) Filed: Jul. 18, 2005

(51) Int. Cl. F16K 31/44

(52) U.S. Cl. 251/213

(57) ABSTRACT

A vacuum gate valve capable of airtightly isolating or interconnecting two vacuum chambers adopts a link lever mechanism to convert a vertical linear dynamic force into a vertical force and a transversal force required for opening or shutting the valve, so as to provide a transversal force large enough to resist the pressure difference between the two vacuum chambers. In the meantime, the invention can prevent an O-ring of the valve from being worn out or damaged when the valve is opened or shut. If the shut valve has no dynamic force, an airtight status will be maintained to isolate the two vacuum chambers. The vacuum gate valve of the invention adopts a low-price flexible sealed tube to lower the cost of the vacuum device.

### FIELD OF THE INVENTION

The present invention relates to a vacuum gate valve, and more particularly to a vacuum gate value capable of airtightly isolating or interconnecting two vacuum chambers.

### BACKGROUND OF THE INVENTION

A vacuum gate valve plays an important role in many types of equipment that adopt the vacuum technology, and these equipments include film manufacturing process equipments for organic, metal or semiconductor materials and relate to a high vacuum system or an ultra-high vacuum system that controls the properties of the surface of a material. The main function of the vacuum gate valve is to provide an airtight valve between two vacuum chambers. If a valve is opened to interconnect two vacuum chambers, matters or fluids can be transmitted between two vacuum chambers through a vacuum gate valve. Individual vacuum chambers may have different internal pressures according to the requirements of a manufacturing process or a vacuum system, so that there is a pressure difference between two vacuum chambers. In general, the pressure difference can reach up to one atmospheric pressure, and the pressure difference thrust exerted on a valve is directly proportional to the effective area of the valve. If the effective area of a valve is 1 m², then the pressure difference thrust exerted on the valve will exceed 10000 Kg. Therefore, a valve has to overcome a very high pressure difference thrust when the valve is closed and exerted by a negative pressure. Furthermore, a vacuum gate valve is usually used together with a valve box connected to two vacuum chambers, and the O-ring disposed at the internal valve contact surface of the valve and the valve box is used to seal the valve and the valve box. If the valve is opened, the valve has to move horizontally to be separated from the internal valve contact surface of the valve box, and then the valve will move vertically to complete the opening process of the valve, so as to avoid the O-ring from being worn out or damaged during its vertical movement. Similarly, if the valve is closed, the valve has to move vertically all the way to the extended horizontal position corresponding to the internal valve contact surface of the valve box, and then move horizontally, so that the internal valve contact surface of the valve and the valve box is sealed to complete the process of closing the valve. The prior art accomplishes the required valve movements as follows in order to make the vacuum gate valve to have the function of repeatedly opening or shutting the valve.

Wedge Vacuum Gate Valve

Referring to FIG. 1A for a schematic view of a wedge vacuum gate valve and FIG. 1B for a schematic view of a valve of the wedge vacuum gate valve, the wedge vacuum gate valve includes a first, a second, and a third pneumatic cylinders 1, 2, 3, a valve 4 linked with a pneumatic cylinder which is comprised of a wedge push board 5 and a latch 6. In FIGS. 1A and 1B, the first pneumatic cylinder 1 applies a force in a direction towards the valve 4 to fix the valve 4 into a position, when the valve is shut. By that time, the wedge push board 5 has not pushed the latch 6 yet, and then the second and third pneumatic cylinders 2, 3 continue applying forces in a direction opposite to the valve 4, so that the wedge push board 5 will push the latch 6 outward to complete the process of shutting the valve. The process of opening the valve is simply a reverse process of the abovementioned process. The drawback of the wedge vacuum gate valve resides on that the wedge push board does not apply enough force to the latch board, so that the valve and the valve contact surface of the vacuum chamber are not airtight and thus causing a leakage easily. Furthermore, when the pneumatic cylinder loses its motive power, the shut valve cannot be fastened to an airtight status.

Parallelogram Vacuum Gate Valve

Referring FIG. 2 A for the schematic view of a parallelogram vacuum gate valve and FIG. 2B for the schematic view of a valve of a parallelogram vacuum gate valve, the parallelogram vacuum gate valve comprises a pneumatic cylinder 7, a guide track 8 and a valve 9 linked to a pneumatic cylinder 7, and the valve 9 has a latch board 10, a force applying board 11, link rods 12, 13, and pilot wheels 14, 15. In FIGS. 2A and 2B, when the valve is shut, the pneumatic cylinder 7 applies a force vertically in a direction towards the valve 9 to push the valve 9. Now, the latch board 10 is attached with the force applying board 11 by the tensile force of a spring. When the valve 9 is moved vertically, the latch board 10 reaches an end of a guide track 8 first, and then the pneumatic cylinder 7 continues applying a force to drive pilot wheels 14, 15 of the force applying board 11 to a fixed position on the guide track 8. Now, the parallelogram is spread out into a rectangle, the force applying board 11 pushes the latch board 10 transversally outward by the link rods 12, 13, so as to complete the process of shutting the valve. When the valve is opened, the process of opening the valve is simply a reverse process of the aforementioned process. The drawback of the parallelogram vacuum gate valve resides on its insufficient tensile force of the spring, and thus the force applying board cannot be attached to the latch board to return to the guide track, when the valve is opened. As a result, the O-ring will be worn out or damaged easily and the shut valve cannot be fastened into an airtight status when the pneumatic cylinder loses its dynamic force.

VAT Vacuum Gate Valve

Referring to FIG. 3 for the schematic view of a VAT vacuum gate valve, the VAT vacuum gate valve comprises a valve body 16, a bellow 17, 18 and a valve 19 disposed on one side. FIG. 3 illustrates a driving mechanism of the valve body installed in the VAT vacuum gate valve, and the driving mechanism includes a complicated combination of a gear, a ruler and a link rod. If the valve is opened, a semicircular groove on a rack will be pivotally coupled with a transmission rod that is pivotally coupled with a link rod and has a gear to prevent the valve from dropping. Now, the bellow 17, 18 is in a contracted status with a smaller length. As shown in FIG. 3, if the valve is closed, the bellow 17, 18 is in an extended status with a larger length, and the valve body includes a semicircular groove disposed on a rack separately on both sides and pivotally coupled with the transmission rod that is pivotally coupled with the link rod and has a gears to prevent the valve 19 from being opened upward. By that time, the gear transmission structure is very rigid and strong and can prevent gas leakages. As described above, after the mechanism of the VAT vacuum gate valve and the valve are opened or shut, it is not necessary to use a force of the pneumatic cylinder to block the valve for the shutting or opening process, but it uses the design of a gear structure to produce a latch force. However, the VAT vacuum gate valve adopts many special designs, such as an O-ring. The O-ring used by VAT is a special one rather than an O-ring of a general specification. VAT creates its own mold for the production, and the shape of its O-ring is in a three-dimensional model, and thus the valve box must have a special internal valve contact surface to fit the special O-ring. In addition, the VAT vacuum gate valves adopt the vacuum feed-through device in the bellow form. The advantage of the feed-through form resides on that the bellow has very low dust content under the vacuum condition, but the selling price of the bellow is very high. As described in the above, the VAT vacuum gate valves adopt the special O-ring and the corresponding valve box produced by VAT, and the scope of its applications is restricted. Furthermore, the bellow also increases the cost of the VAT vacuum gate valves.

### SUMMARY OF THE INVENTION

It is a primary objective of the present invention to solve the foregoing problems and overcome the shortcomings of the prior art by providing a vacuum gate valve whose valve can be opened and closed repeatedly. Its simple lever mechanism provides sufficient transversal forces to shut and open the valve airtightly, so as to prevent the internal contact surfaces of the O-ring and the valve box from being worn out or damaged during the transversal movements. After the valve is shut, no additional force is needed to automatically lock the valve in a shut status, and the invention also adopts the design of general valves and O-rings to fit the internal valve contact surface of the valve box. Thus the scope of applications of the vacuum gate valve according to the present invention is not restricted. Further, the present invention substitutes the expensive bellow by a low-priced flexible sealed tube, and thus can lower the cost.

A vacuum gate valve in accordance with the present invention comprises: a valve body with an end coupled to a valve box, and the valve box having a dynamic unit; a link board with both ends movably and pivotally coupled to both sides of the valve body, and the link board being pivotally coupled to the dynamic unit, and the link board being pivotally coupled with the dynamic unit; a transmission unit including a flexible sealed tube and a transmission rod, and the flexible sealed tube wraps a portion between a dynamic end of the transmission rod and a valve end, and the dynamic end being protruded from a movable end of the flexible sealed tube and installed at the link board, and a fixed end at the other end of the flexible sealed tube being coupled to an end of the valve body that is coupled to the valve box, such that the valve end of the transmission rod installed in a pivot hole of the valve body is extended into the valve box; and a valve installed at the valve end of the transmission rod inside the valve box, and the side of the valve facing the front side of the valve body includes an airtight flange on a single plane.

### BRIEF DESCRIPTION OF THE DRAWINGS

FIG. 1A is a schematic view of a wedge vacuum gate valve;

FIG. 1B is a schematic view of a valve of a wedge vacuum gate valve;

FIG. 2A is a schematic view of a parallelogram vacuum gate valve;

FIG. 2B is a schematic view of a valve of a parallelogram vacuum gate valve;

FIG. 3 is a schematic view of a VAT vacuum gate valve;

FIG. 4 is a schematic view of a vacuum gate valve according to a preferred embodiment of the present invention;

FIG. 5 is an exploded view of a vacuum gate valve according to a preferred embodiment of the present invention;

FIG. 6 is a cross-sectional view of a vacuum gate valve according to a preferred embodiment of the present invention;

FIG. 7A is a perspective view of a vacuum gate valve according to a preferred embodiment of the present invention;

FIG. 7B is a side view of a vacuum gate valve according to a preferred embodiment of the present invention;

FIG. 7C is a front view of a vacuum gate valve according to a preferred embodiment of the present invention;

FIG. 8A is a perspective view of a vacuum gate valve using a wider valve according to a preferred embodiment of the present invention; and

FIG. 8B is a front view of a vacuum gate valve using a wider valve according to a preferred embodiment of the present invention,

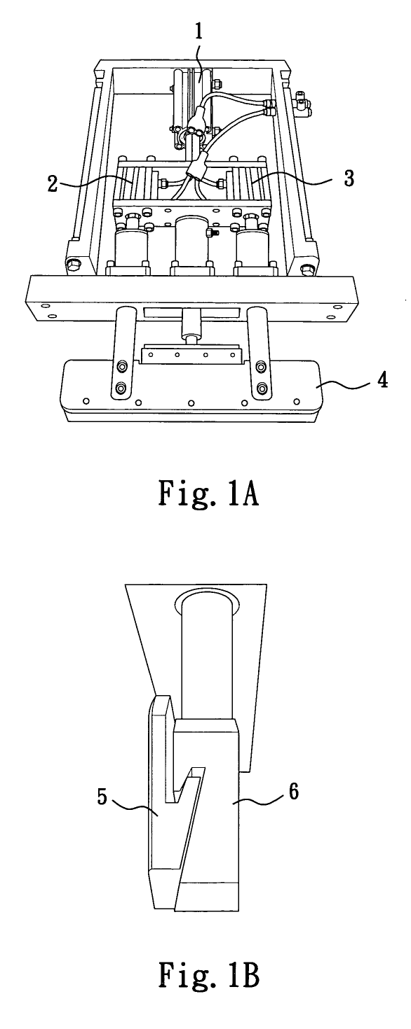

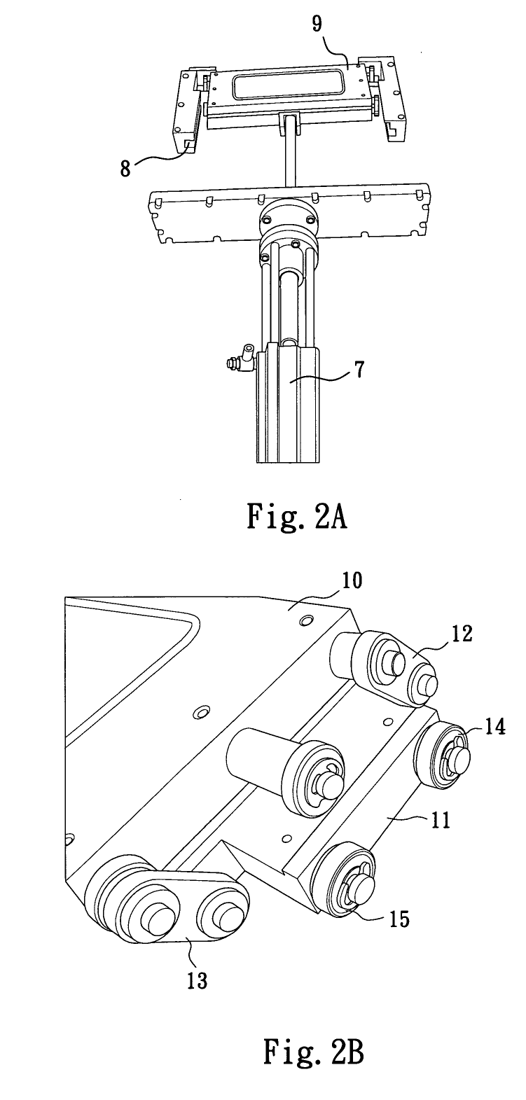

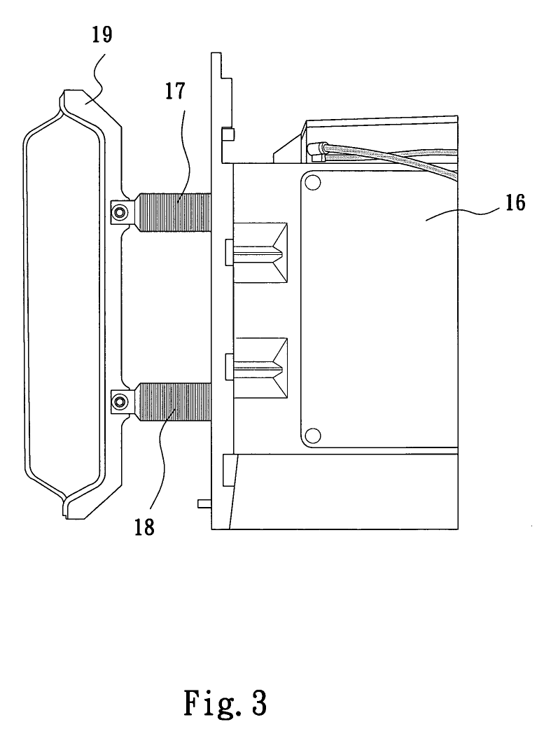

### DETAILED DESCRIPTION OF THE PREFERRED EMBODIMENTS

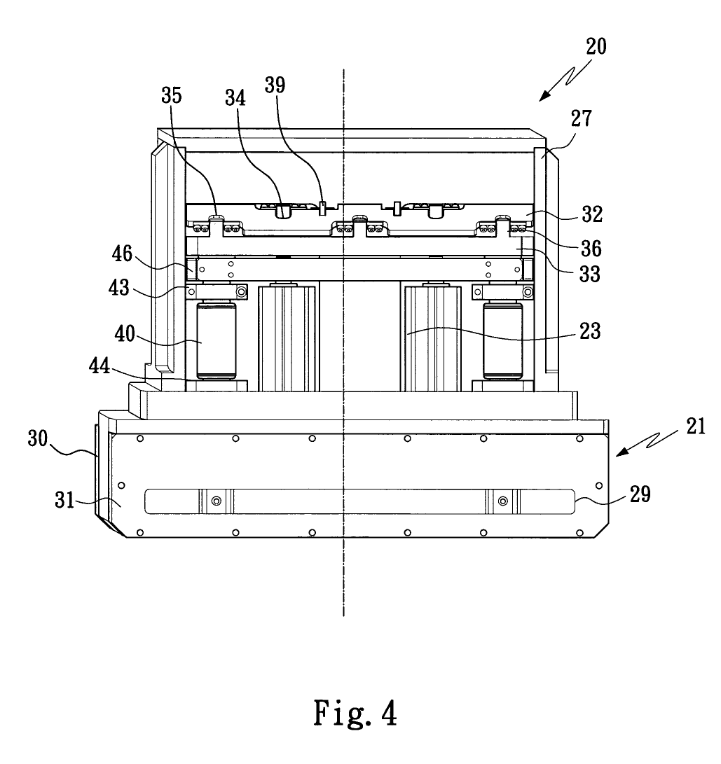

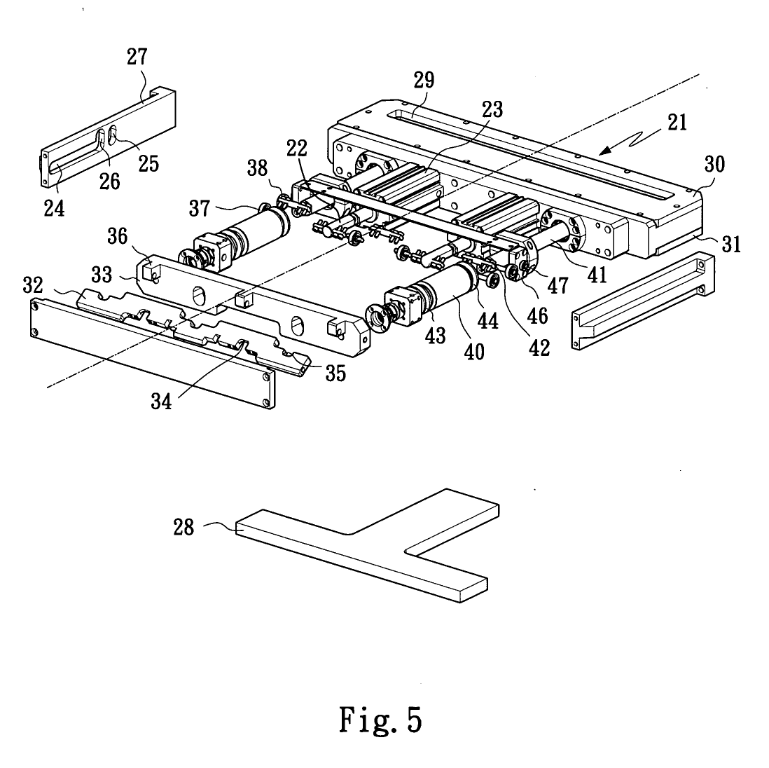

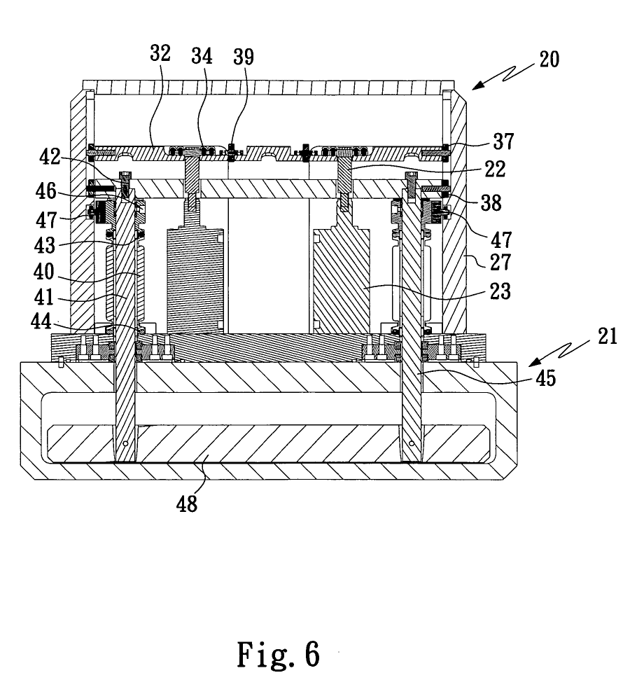

Refer to FIGS. 4, 5 and 6 respectively for the schematic view, the exploded view, and the cross-sectional view of a vacuum gate valve according to a preferred embodiment. To avoid the complicated labeled elements that make the reading of this specification difficult, a dotted line representing a line of symmetry of a mirror is used in FIGS. 4 to 6, and only the elements on one side of the line of symmetry are labeled for simplicity. In FIGS. 4 to 6, a vacuum gate valve in accordance with the present invention comprises: a valve body 20 having an end coupled to a valve box 21, and the valve body 20 installs a pneumatic cylinder 23 as a dynamic unit having a piston rod 22, a vertical first guide track 24 and a transversal second guide track 25, and the first guide track 24 includes a curved slot 26 disposed at an end of the valve body 20 proximate to the valve box 21 and transversally bent towards another side 27 of the front side of the valve body 20. A pilot wheel blocking panel 28 (not shown in FIG. 4) is installed at the front side of the valve body 20, and the valve box 21 has a valve hole 29 therein, and an internal valve contact surface is disposed on the edge of the valve hole 91 on the back of the front side of the valve body 20, and the valve box 21 has two vacuum chamber contact surfaces 30, 31 on both sides respectively facing and having its back facing the front side of the valve body 20; a link board is comprised of both ends pivotally coupled to a thrust board 32 and a link structure board 33 on both sides of the valve body 20, and the link structure board 33 is disposed on a thrust board 32 and facing a side of the valve box 21, and the thrust board 32 includes a first pivot section 34 and a second pivot section 35, and the first pivot section 34 is situated along the pivotal axis of the thrust board 32 and the valve body 20, and the second pivot section 35 is situated on one side of the pivotal axis of the thrust board 32, and the first pivot section 34 is pivotally coupled with an end of the pneumatic cylinder 23 piston rod 22, and the second pivot section 35 is pivotally coupled to a side of the link structure board 33 that includes a pivot of the second pivot section. The thrust board 32 and both ends of the link structure board 33 are respectively and pivotally coupled to a thrust board pilot wheel 37 and a link structure board pilot wheel 38 and embedded into the first guide track 24 on both sides of the valve body 20. The thrust board 32 further includes a pilot wheel 39 disposed on the pivotal axis for providing a reaction force and being in contact with the pilot wheel blocking panel 28 for rolling. The transmission unit is comprised of a flexible sealed tube 40 and a transmission rod 41, and the flexible sealed tube 40 is a flexible metal tube sealing the portion between the dynamic end 42 and the valve end. The dynamic end 42 is protruded from the movable end 43 of the flexible sealed tube 40 and installed on the link structure board 33 of the link board. The fixed end 44 at the other end of the flexible sealed tube 40 is fixed to the valve body 20 at an end coupled to the valve box 21, such that the valve end of the transmission rod 41 is protruded through a pivot hole 45 of the valve body 20 into the valve box 21, and the movable end 43 of the flexible sealed tube 40 has two ends pivotally coupled to the swinging device 46 of the valve body 20 and disposed between the link board and the movable end 43 of the flexible sealed tube 40. The dynamic end 42 of the transmission rod 41 passes through the crevice of the swinging device 46 at the link structure board 33, and both ends of the swinging device 46 have a swinging device pilot wheel 47 being embedded into the transversal second guide tracks 25 on both sides of the valve body 20. A valve 48 is installed at the valve end of the transmission rod 41 in the valve box 21, and the valve 48 has a circular groove on a single plane facing the front side of the valve body 20 and embedded to form an O-ring with an airtight flange for sealing the internal valve contact surface of valve hole 29 on the valve box 21, when the valve is shut.

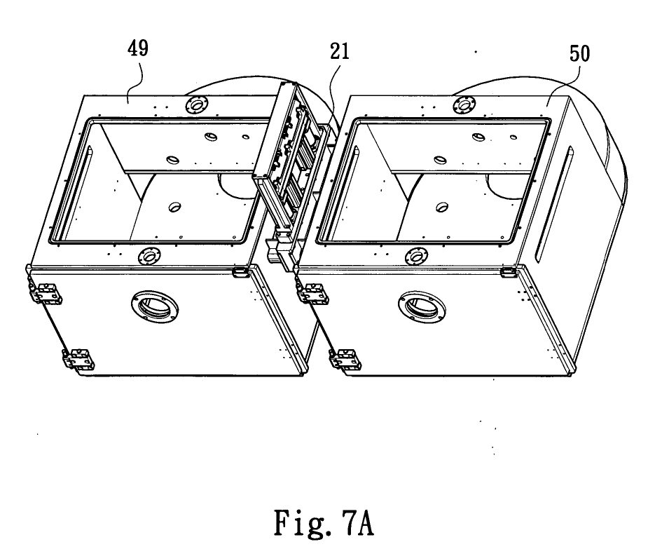

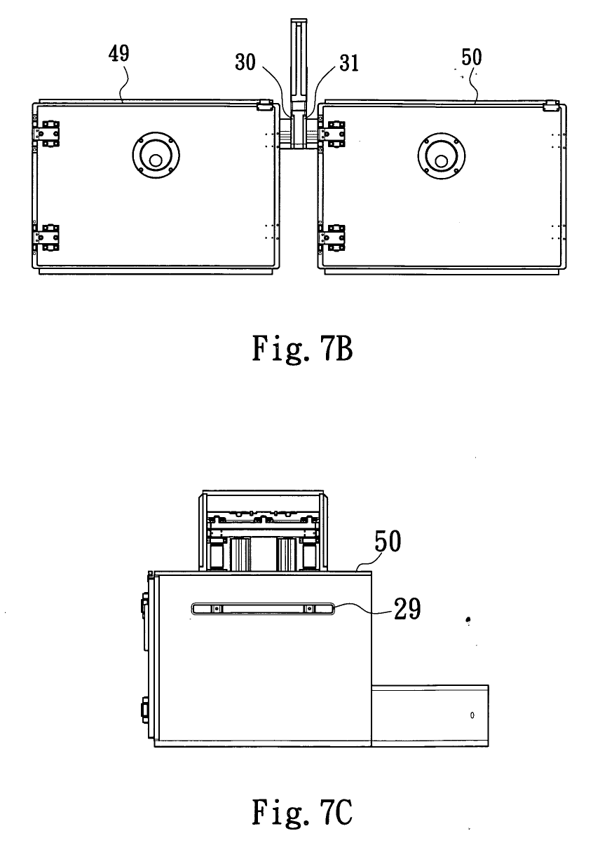

Referring to FIGS. 7A, 7B, and 7C respectively for the perspective view of a vacuum gate valve, the side view that is viewed along the direction perpendicular to the direction of serially connecting the vacuum chamber, and the side view that is view along the direction of connecting the vacuum chamber according to a preferred embodiment of the present invention, two vacuum chamber contact surfaces 30, 31 of the valve box 21 of the vacuum gate valve are respectively sealed with two vacuum chambers 49, 50, so that the valve hole 29 of the valve box 21 is serially interconnected with the crevice and cavity of the two vacuum chamber 49, 50 for transmitting objects or fluids through the valve hole 29 between the two vacuum chambers 49, 50 if the valve is opened, and keeping the two vacuum chambers 49, 50 isolated from each other if the valve is shut.

Referring to FIGS. 4 to 6, the movement of the vacuum gate valve in accordance with a preferred embodiment of the present invention is described as follows. If the valve 48 of the vacuum gate valve is opened, the valve hole 29 of the valve box 21 is not sealed; and if the valve is shut, the piston rod 22 of the pneumatic cylinder 23 drives the first pivot section 34 of the thrust board 32, so that the thrust board 32 and the link structure board 33 displace vertically with the link structure board pilot wheel 38 along the first guide track 24 towards the valve box 21, and the included angle between the thrust board 32 and the link structure board 33 is maintained at a positive value of 60 degrees until the link structure board pilot wheel 38 of the link structure board 33 reaches the transversal curve of the first guide track 24. By that time, the valve 48 reaches the transversal extended position of the valve hole 29 of the valve box 21 but is not in contact with its internal valve contact surface, and the piston rod 22 of the pneumatic cylinder 23 continues applying a force to the first pivot section 34 of the thrust board 32 in a direction towards the valve box 21, and the thrust board 32 is acted by the pilot wheel 39 with a reaction force from the pilot wheel blocking panel 28 and by the first guide track 24 with a transversal force of the thrust board pilot wheel 37. Therefore, the second pivot section 35 of the thrust board 32 applies a transversal force to the pivot 36 of the second pivot section 35 of the link structure board 33, so that the link structure board pilot wheel 38 of the link structure board 33 transversally enters into the curved slot 26. By that time, the dynamic end 42 of the transmission rod 41 of the link structure board 33 has a transversal movement on another side of the front side of the valve body 20, and the swinging device pilot wheel 47 of the swinging device 46 moves transversally along the second guide track 25, so that the flexible sealed tube 40 at the movable end 43 having the swinging device 46 is bent about 2 degrees towards another curved surface of the front side of the valve body 20. In the meantime, the transmission rod 41 carries out a lever movement with the pivot hole 45 disposed at the valve body 20, such that the valve 48 at the valve end of the transmission rod 41 moves transversally towards the front side of the valve body 20 to seal the valve hole 29 and airtightly contact the internal valve contact surface, so as to complete the process of shutting the vacuum gate valve. In the foregoing process of shutting the vacuum gate valve, the thrust board 32 rotates with respect to its second pivot section 35 when the link structure board pilot wheel 38 of the link structure board 33 enters into the end of a locking groove, such that the included angle between the thrust board 32 and the link structure board 33 is decreased from a positive value of approximately 60 degrees to a negative value of approximately −5 degrees. By the force of the powerful structure of the valve body 20 with the thrust board 32, link structure board 33, and pivot hole 45, the dynamic end 42 of the transmission rod 41 is secured to define a securely locking status for the link board. Therefore, it is not necessary to use the motive force of the pneumatic cylinder 23 to assure an airtight status of the vacuum gate valve. If the valve is in an open status, the piston rod 22 of the pneumatic cylinder 23 applies a force to the first pivot section 34 of the thrust board 32 in a direction away from the valve box 21, and the thrust board 32 rotates about its second pivot section 35, so that the included angle between the thrust board 32 and the link structure board 33 is changed from a negative value of −5 degrees to a positive value of 60 degrees to release the locking status of the link board. Now, the link structure board pilot wheel 38 of the link structure board 33 draws back transversally from the curved slot 26, and the dynamic end 42 of the transmission rod 4 of the link structure board 33 moves transversally towards the front side of the valve body 20. The winging device pilot wheel 47 of the swinging device 46 moves transversally along the second guide track 25, such that the movable end 43 of the flexible sealed tube 40 having a swinging device 46 is bent about 2 degrees towards the front side of the valve body 20. In the meantime, the transmission rod 41 carries out a lever movement at the pivot hole 45 of the valve body 20, and the valve at the valve end 48 of the transmission rod 41 moves transversally towards another side of the front side of the valve body 20 and is separated from the internal valve contact surface. The piston rod 22 applies a force on the first pivot section 34 of the thrust board 32 in a direction away from the valve box 21, so that the thrust board 32 and the link structure board 33 displace vertically according to the link structure board pilot wheel 38 along the first guide track 24 in a direction away from the valve box 21 until the transmission rod 41 pulls the valve 48 back to a position of not covering the valve hole 29, so as to complete the process of opening the vacuum gate valve. It is worth to point out that the flexible sealed tube of the present invention needs to be bent about 2 degrees only and does not need to have the function of extending or contracting its length, and thus avoiding using an expensive soft sealed tube.

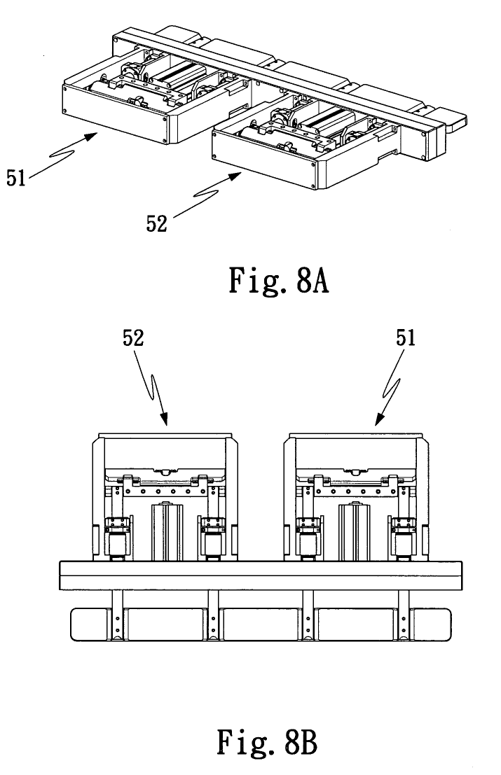

Refer to FIG. 8A for a perspective view of a vacuum gate valve using a wider valve (larger than 1.3 m) according to a preferred embodiment of the present invention. If the valve is used for a large vacuum chamber, the first vacuum gate valve 51 and the second vacuum gate valve 52 are connected in parallel to comply with the sealed vacuum requirements. FIG. 8B is a schematic view of the front side of this valve used for a large vacuum chamber.

In summation of the description above, the present invention meets the three requirements of patentability: novelty, non-obviousness and usefulness. As to the novelty and usefulness, the present invention overcomes the shortcoming of having insufficient transversal forces to maintain the airtight connection between the valve and the valve contact surface of the vacuum chamber. The present invention improves the condition that the valve cannot maintain an airtight condition of a shut valve when there is no motive force, and the valve cannot be separated from the valve contact surface of the vacuum chamber, and the O-ring is worn out or damaged. The invention also overcomes the shortcoming of the prior art that adopts a special valve and a special O-ring for a limited scope of applications. The invention substitutes the expensive soft sealed tube by the flexible sealed tube, so as to lower the costs. The products produced according to the present invention can fully meet the requirements of the market.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A vacuum gate valve, comprising:
a valve body, having an end coupled to a valve box, and said valve body having a dynamic unit;
a link board, having both ends movably and pivotally coupled to both sides of said valve body, and said link board being pivotally coupled to said dynamic unit;
a transmission unit, including a flexible sealed tube and transmission rod, and said flexible sealed tube sealing a portion between a dynamic end and a valve end of said transmission rod, and said dynamic end being protruded from a movable end of said flexible sealed tube and installed at said link board, and said fixed end which is at another end of said flexible sealed tube being coupled to said valve body and one end of said valve box, such that said valve end of said transmission rod is extended into said valve box through a pivot hole of said valve body; and
a valve, installed at a valve end of said transmission rod in said valve box, and an airtight flange being disposed on a single plane on said valve facing the front side of said valve body.

2. The vacuum gate valve of claim 1, wherein said link board further comprises two ends pivotally coupled to a thrust board and a link structure board on both sides of said valve body, and said link structure board being situated on a side of said thrust board facing said valve box, and a thrust board including a first pivot section and a second pivot section, and said first pivot section being situated on a pivotal axis where said thrust board and valve body being pivotally coupled for coupling said dynamic unit, and said second pivot section being situated on one side of the pivotal axis of said thrust board for pivotally coupling one side of said link structure board, and said movable end of said flexible sealed tube including a swinging device having both ends pivotally coupled to both sides of said valve body and disposed between said link board and said flexible sealed tube, and said dynamic end of said transmission rod being disposed at said link structure board.

3. The vacuum gate valve of claim 2, wherein said thrust board includes a thrust board pilot wheel and a link structure board pilot wheel respectively and pivotally coupled to both ends of said link structure board for being embedded into a first guide track disposed on both sides of said valve body, such that said thrust board and link structure board carry out a vertical movement facing or having their backs facing the front side of said valve box, and said swinging device includes a swinging device pilot wheel being embedded into a second guide track on both sides of said valve body, such that said thrust board and link structure board carry out a transversal movement facing or having their backs facing the front side of said valve box.

4. The vacuum gate valve of claim 3, wherein said first guide track includes a curved slot at an end of said valve body facing said valve box, such that said link structure board can carry out a transversal movement on the side facing and having its back facing the front side of said valve body, and said link structure board pilot wheel can enter into said curved slot to securely lock said link board.

5. The vacuum gate valve of claim 1, wherein said dynamic unit further comprises a pneumatic cylinder having a piston rod, and an end of said piston rod is pivotally coupled to said link board.

6. The vacuum gate valve of claim 1, wherein said valve box comprises a valve hole therein, an internal valve contact surface disposed on the edge of said valve hole with its back facing the front side of said valve body, and two vacuum chamber contact surfaces disposed on two sides of said valve box respectively facing and having its back facing the front side of said valve body.

7. The vacuum gate valve of claim 2, wherein said valve body includes a pilot wheel blocking panel disposes at a front side thereof, and said thrust board includes at least one pilot wheel disposed on said pivotal axis for providing a reaction force and being in contact with said pilot wheel blocking panel for a rolling.

8. The vacuum gate valve of claim 1, wherein said valve includes a circular groove and an O-ring embedded into said circular groove to form said airtight flange.
